(19) United States
(12) Patent Application Publication
(10) Pub. No.: US 2017/0060941 A1
(43) Pub. Date: Mar. 2, 2017

(54) Systems and Methods for Searching Heterogeneous Indexes of Metadata and Tags in File Systems

(71) Applicant: Futurewei Technologies, Inc., Plano, TX (US)

(72) Inventors: Ning Yan, Santa Clara, CA (US); Stephen Morgan, San Jose, CA (US)

(21) Appl. No.: 14/835,399

(22) Filed: Aug. 25, 2015

(51) Int. Cl. G06F 17/30

(52) U.S. Cl. CPC G06F 17/30439; G06F 17/30327; G06F 17/30336

(57) ABSTRACT

An apparatus for processing queries in a heterogeneous index. The apparatus comprises a receiver configured to receive a query from a user, wherein the query comprises at least one desired attribute of a desired file, and a processor coupled to the receiver and configured to search the heterogeneous index. The processor is configured to search the heterogeneous index by receiving the query from the receiver, testing a bloom filter of a storage partition in the heterogeneous index for existence of the desired attribute after receipt of the query, ignoring the storage partition and proceeding to a next storage partition in the heterogeneous index when the bloom filter indicates that the desired attribute is not present in the storage partition, and searching the storage partition to determine which one or more files of the storage partition have the desired attribute when the bloom filter indicates that the desired attribute is present in the storage partition.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Stores of data are increasing in size at a rapid pace. To utilize these data stores, effective and efficient means of searching the stores and providing basic maintenance to keep the stores up to date and valid may be desirable. In addition, it may be desirable to have the ability to use plain language text to identify pieces of data as opposed to technical details of the data. As a result, a process for searching both the plain language text identifications and technical details to obtain a resulting file may be desirable.

### SUMMARY

In one embodiment, the disclosure includes an apparatus for processing queries in a heterogeneous index. The apparatus comprises a receiver configured to receive a query from a user, wherein the query comprises at least one desired attribute of a desired file, and a processor coupled to the receiver and configured to search the heterogeneous index. The processor is configured to search the heterogeneous index by receiving the query from the receiver, testing a bloom filter of a storage partition in the heterogeneous index for existence of the desired attribute after receipt of the query, ignoring the storage partition and proceeding to a next storage partition in the heterogeneous index when the bloom filter indicates that the desired attribute is not present in the storage partition, and searching the storage partition to determine which one or more files of the storage partition have the desired attribute when the bloom filter indicates that the desired attribute is present in the storage partition.

In another embodiment, the disclosure includes a method for updating a heterogeneous search index for a storage partition. The method comprises receiving an update message from a user, wherein the update message indicates an operation to be performed on the heterogeneous search index that comprises attributes comprising metadata and tags, recording a log entry indicating receipt of the update message from the user; determining the operation that is to be performed according to the update message, updating the heterogeneous search index according to the update message, and recording a log entry indicating that the update message received from the user was executed successfully.

In yet another embodiment, the disclosure includes a method of recovering from a system failure in a heterogeneous search index. The method comprises entering a plurality of actions to be performed into a log at a time of receipt prior to execution of the actions, wherein the actions to be performed comprise at least two of updating a bloom filter of the heterogeneous search index that indicates an existence of a tag or metadata in the heterogeneous search index, updating a k-dimensional tree of the heterogeneous search index, and updating a key-value store of the heterogeneous search index, and entering the actions performed into the log at a time of completion to indicate successful execution of a first of the actions and a progression to a second of the actions.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is an illustration of a network element readable file including file metadata and tags.

FIG. 2 is a schematic diagram of an embodiment of an index server.

FIG. 3 is a flowchart of an embodiment of an index server query process.

FIG. 4 is a flowchart of an embodiment of an index server insertion or deletion and update process.

FIG. 5 is a schematic diagram of an embodiment of an index server cluster system.

FIG. 6 is a schematic diagram of an embodiment of a network element for index searching.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein is a manner for establishing an index of file attributes that includes both machine-readable metadata and semantic tags. The disclosed embodiments facilitate searching of the index according to queries received from a user. File storage space is divided into a plurality of partitions for storing files and their accompanying attribute indexes for searching. Each partition includes a bloom filter for indicating the existence of a given attribute in the partitions, a k-dimensional tree for indexing fixed categories of metadata, and a plurality of key-value stores that each index one category of tag. Utilizing hash tables that record the presence of a file in a partition, the k-dimensional and key-value store indexes may be updated and maintained according to update messages received from a user. By creating a log of the update messages received from the user and the updates messages that are successfully executed, a log-based recovery process may be established.

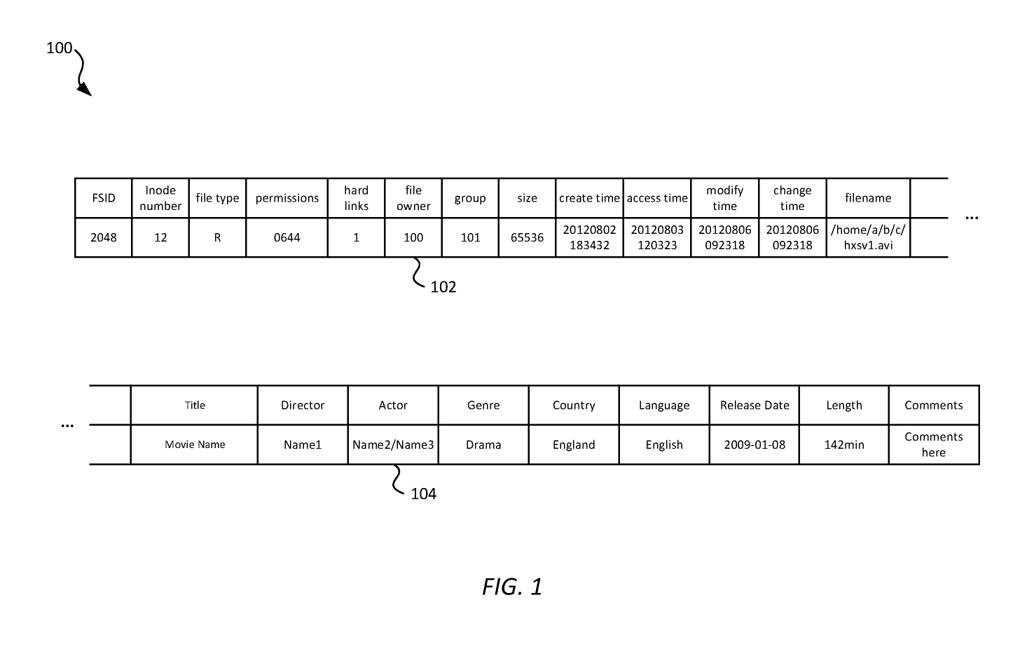

FIG. 1 is an embodiment of a network element readable file 100, or media file, including file metadata and tags. Network element readable files are labeled with a plurality of pieces of information to aid in identifying, searching, ordering, indexing, presenting, or otherwise interacting with the network element readable file. Metadata 102 illustrates one example of labeling for a network element readable file. In some embodiments, metadata 102 may be referred to as machine-readable file attributes and comprise technical details about the network element readable file that are automatically generated. Metadata 102 includes, for example, a file system identification value, mode number, file type, file access permissions, file hard link, file owner, group, file size, file creation timestamp, file access timestamp, file modification timestamp, file change timestamp, file name, and/or other technical file attributes of a like nature.

Tags 104 illustrate another example of labeling for a network element readable file. In some embodiments, tags 104 may be referred to as human-readable file attributes and comprise semantic details about the network element readable file that are introduced by a user. For a network element readable file that is, for example a movie, tags 104 include, for example, a title, director, list of one or more actors, genre, country of origin, language, release data, length, comments, and/or other semantic details of a like nature. For a network element readable file that is, for example an audio file, tags 104 include, for example, a song name, one or more singer names, an album name, one or more producer names, a track number, and/or other semantic details of a like nature.

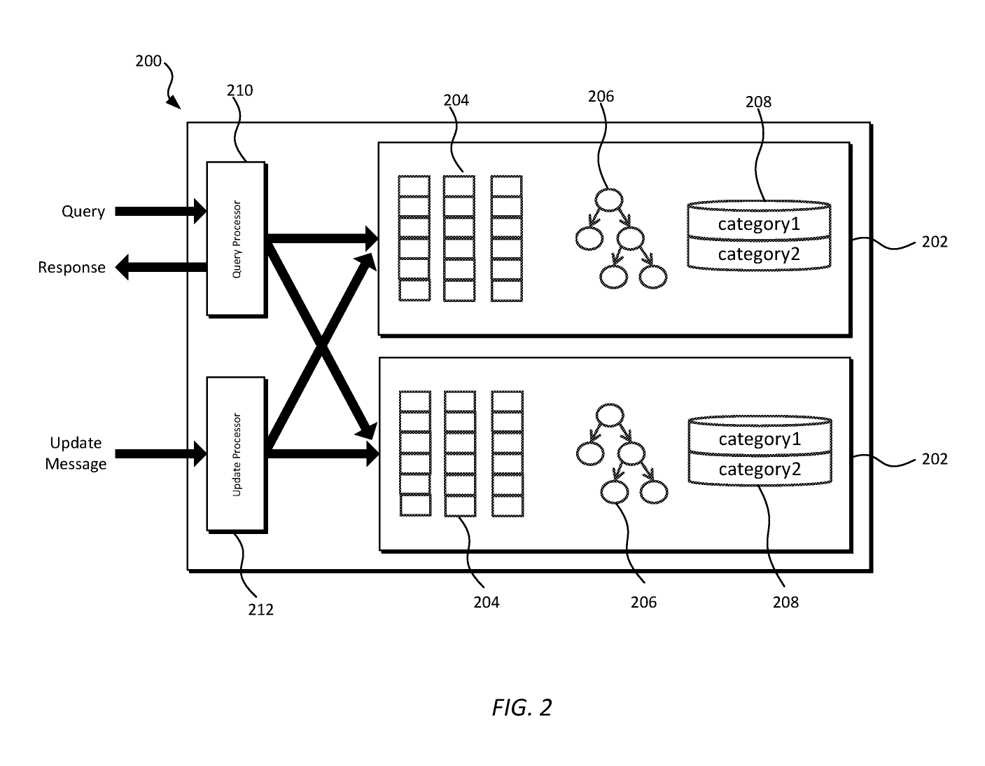

FIG. 2 is a schematic diagram of an embodiment of an index server 200. Server 200 comprises one or more partitions 202, each comprising one or more bloom filters 204 that indicate a file attribute existing in the partition, a k-dimensional tree (kd-tree) index 206 that indexes a plurality of fixed file metadata fields, for example metadata 102, shown in FIG. 1, and one or more key-value stores (kv-stores) 208 that each index one category of file tags, for example tags 104, shown in FIG. 1, or dynamic file metadata fields. In an embodiment, each partition 202 represents a portion of available file space on server 200 and comprises one kv-store 208 for each category of tag that is indexed in the partition 202. For example, a partition 202 indexing four tag categories (e.g., title, actor, director, and genre) will comprise four kv-stores 208 with each kv-store 208 having one associated tag category. In an embodiment, each partition 202 further comprises one kv-store 208 for each dynamically added metadata category. Server 200 further comprises a query processor 210 for processing query requests and an update processor 212 for processing insertion, deletion, and/or update requests.

When a network element readable file having metadata and/or tags associated with the file is added to a partition 202, the file is added to a hash table within the partition 202 to record the presence of the file in that partition 202. Additionally, the metadata of the file is indexed in the kd-tree index 206 of the partition 202, and the tags of the file are indexed in the kv-stores 208 that correspond to the respective tag category.

Query processor 210 receives a query comprising one or more query attributes from a user. The query attributes may be any combination of metadata and/or tags that identify a network element readable file for which a search is occurring. The query processor 210 parses the query and tests each bloom filter 204 of each partition 202 for the presence of the query attributes. In one embodiment, each partition 202 comprises one bloom filter 204 for each file attribute, for example metadata and/or tag, which is indexed in that partition 202. For example, in a server 200 in which each partition 202 indexes twenty-seven combined metadata and tag file attributes, each partition 202 will comprise twenty-seven bloom filters 204. Generally, where each partition 202 indexes N file attributes, each partition 202 will comprise N bloom filters 204.

Each bloom filter 204 comprises a plurality of bits, where each bit serves as an indicator of the presence of a particular file attribute in the partition 202 in which the bloom filter 204 is located. For example, when a query comprising one or more query attributes is tested against bloom filters 204 by query processor 210, the query attributes are compared to the bits of the bloom filter 204 to determine whether a file having the query attributes is present in the particular partition 202 in which the bloom filters 204 are located. When a query processor 210 receives a positive response from a bloom filter 204 that indicates a high probability of a file having the desired query attributes being present in the partition 202 in which the bloom filter 204 is located, the query processor 210 searches the kd-tree index 206 and kv-stores 208 to identify the files having the desired query attributes and returns those files to the user.

Network element readable files stored in a partition 202 may be deleted from the partition 202, additional network element readable files maybe inserted into the partition 202, and/or existing network element readable files in the partition 202 may be updated with one or more modified metadata fields and/or tags. In an embodiment, update processor 212 receives from a user, a request comprising one or more actions to be performed in a partition 202. As described above, the action may be the insertion of a network element readable file into the partition 202, the deletion of a network element readable file from the partition 202, or the update of metadata or tags in an already existing network element readable file in the partition 202. When an action is taken in the partition 202 by update processor 212, corresponding updates are made to bloom filters 204, kd-tree index 206, and kv-stores 208 to reflect changes in the metadata and/or tags that are present in the partition 202 subsequent to the action being performed by update processor 212.

It is understood that in one embodiment the query processor 210, the update processor 212, and the partitions 202 are co-located on the same device, for example a single network element as described in further detail below. It is also understood that alternative embodiments exist such that the query processor 210, the update processor 212, and the partitions 202 are distributed among a plurality of devices, for example in a cloud computing environment. For example, in one embodiment, the query processor 210 and update processor 212 may be located on a first device and the partitions 202 may be located on a second device, for example a network attached storage device.

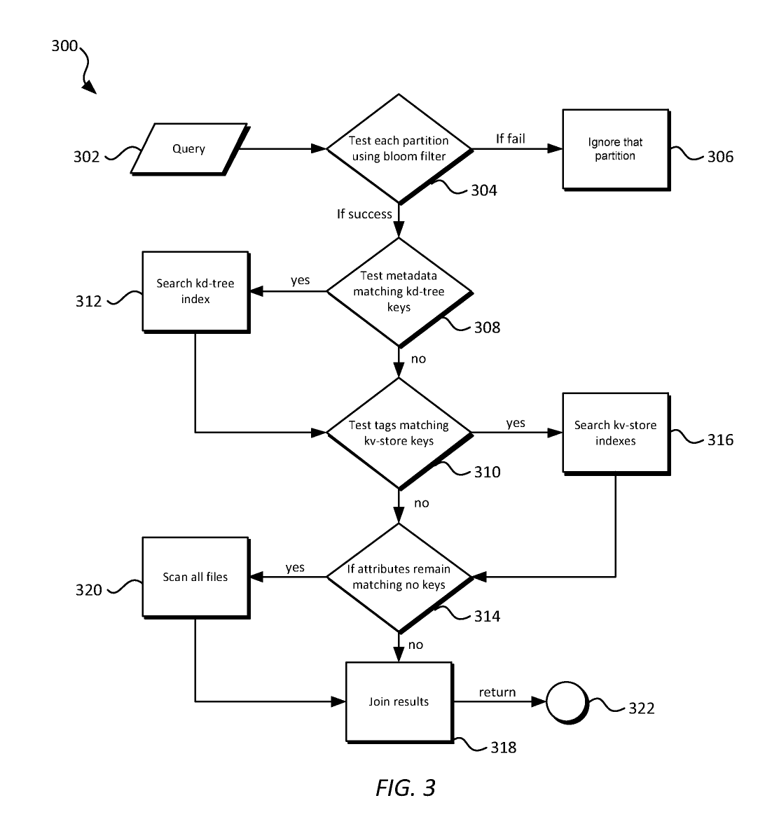

FIG. 3 is a flowchart of an embodiment of an index server query process 300. The method 300 may be implemented, for example, to efficiently search an index of file attributes in response to a query from a user. At step 302, a query is received by a query processor, for example query processor 210, shown in FIG. 2. The query comprises one or more attributes for which a corresponding network element readable file is desired. At step 304, the query processor tests a first partition, for example a partition 202, shown in FIG. 2, in an index server, for example server 200, shown in FIG. 2, using bloom filters, for example bloom filters 204, shown in FIG. 2, to determine the probability of a file existing in that particular partition that has the attributes indicated in the query. The query processor receives a response from the bloom filters indicating either that the desired attributes definitely do not exist in the partition, or that the desired attributes probably exist in the partition. When the query processor receives a response from the bloom filters indicating that the desired attributes definitely do not exist in the partition, at step 306 the query processor ignores the particular partition and continues process 300 in the remaining partitions of the index server.

When the query processor receives a response from the bloom filters indicating that the desired attributes probably exist in the partition, at step 308 the query processor tests the partition's kd-tree index, for example kd-tree index 206, shown in FIG. 2, for metadata matching kd-tree keys. When metadata matching kd-tree keys are found, at step 312 the query processor searches the kd-tree index to identify the particular network element readable files having the metadata indicated by the query. After searching the kd-tree index to identify the particular network element readable files having the metadata indicated by the query, or if metadata matching kd-tree keys are not found at step 308, the query processor tests kv-stores, for example kv-stores 208, shown in FIG. 2, at step 310 to determine whether tags from the query match kv-store keys.

When tags matching kv-store keys are found, at step 316 the query processor searches the kv-store indexes to identify the particular network element readable files having the metadata indicated by the query. After searching the kv-store index to identify the particular network element readable files having the tags indicated by the query, or if tags matching kv-store keys are not found at step 310, the query processor determines at step 314 whether attributes from the query were not found in either the kd-tree index at step 308 or the kv-store index at step 310. When attributes from the query were not found in either index, at step 320 the query processor scans all files in the partition to find any that match the query. At step 318, the query processor joins the results of the kd-tree search at step 312, the kv-store index search at step 316, and the scan of all files at step 320 prior to returning the results to the user at step 322.

In an alternative embodiment of process 300, the kv-store is searched prior to the kd-tree, such that one or both of step 310 and step 316 may be performed before one or both of step 308 and step 312. In another alternative embodiment of process 300, the kd-tree is searched prior to the kv-store. In another alternative embodiment of process 300, the kv-store and the kd-tree are searched substantially simultaneously, e.g., on a network element having a plurality of processors and/or a plurality of cores, such that the search of the kv-store and the search of the kd-tree begin and/or end at approximately the same time.

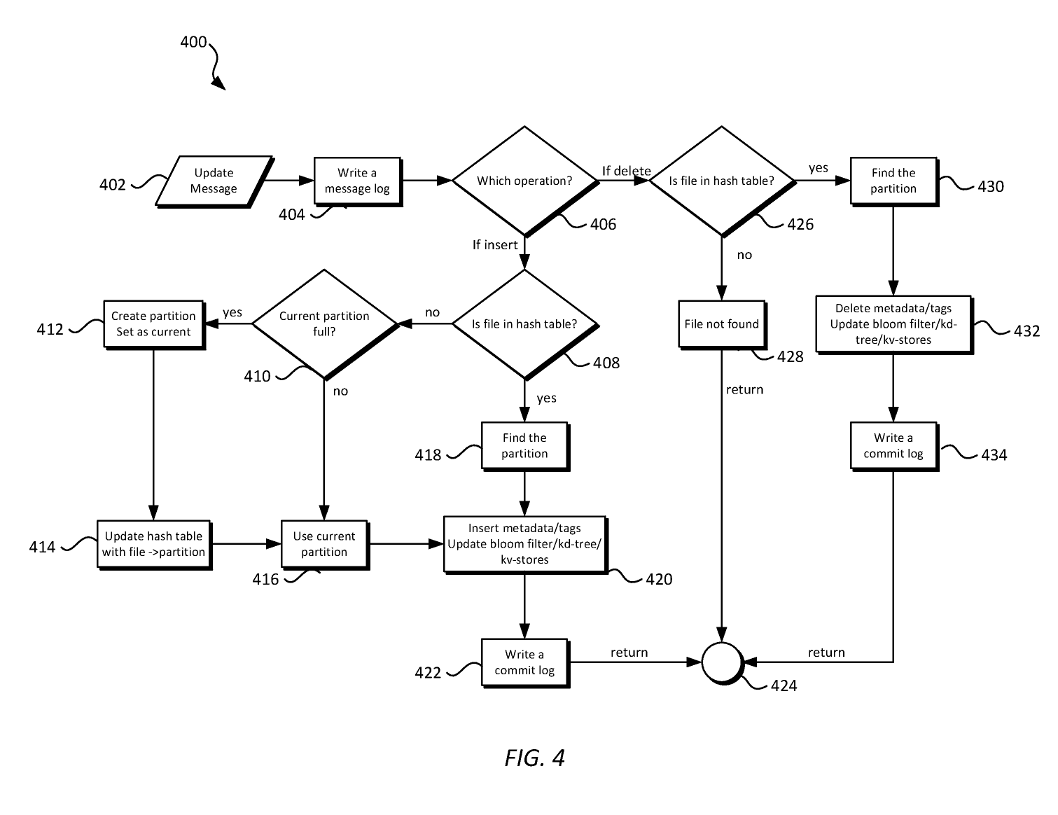

FIG. 4 is a flowchart of an embodiment of an index server insertion or deletion and update process 400. The update process 400 may be implemented, for example, in response to an update processor receiving an update message corresponding to a partition. At step 402, an update message is received by an update processor, for example update processor 212, shown in FIG. 2. The update message indicates an action that is to be performed in a partition, for example a partition 202, shown in FIG. 2. The action may be to insert a network element readable file into the partition, delete a network element readable file from the partition, or update metadata or tags associated with a network element readable file already in the partition, and then update one or more indices, for example a kd-tree index and/or a kv-store index as discussed above in FIG. 2.

At step 404, the update processor writes a message log. The message log records the contents of the update message, and is maintained for future use or reference, for example, in a backup system as described below. At step 406, the update processor determines what operation is specified by the update message. If the update message indicates that a file is to be inserted into the partition or that an existing file in the partition is to be updated with new metadata and/or tags, at step 408 the update processor determines whether the file is present in the partition's hash table, as described above. If the file is not in the partition's hash table, at step 410 the update processor determines whether the partition has space available for the file or if the partition is full. When the partition is full, at step 412 the update processor creates a new partition and designates that partition as the current partition before updating the hash table at step 414 to indicate that the file has been placed in the newly created partition. After updating the hash table, or if the partition at step 408 was determined to have space available for the file, at step 416 the update processor uses the currently designated partition for further action.

If, at step 408, the file was found in the hash table and therefore will have its metadata and/or tags updated, at step 418 the update processor finds the file in the partition. At step 420, the update processor inserts the metadata and/or tags associated with the file for insertion into the partition determined in steps 416 or 418, and updates the partition's bloom filters, kd-tree, and kv-stores to reflect the new file and its associated metadata and/or tags. At step 422, the update processor writes a commit message indicating that the tasks in the update message that were noted in the message log at step 404 have been completed prior to returning at step 424.

If, at step 406, the update processor determines that the update message indicates that a file is to be deleted from the partition, at step 426 the update processor determines whether the file is present in the partition's hash table, as described above. If the file is not in the partition's hash table, at step 428 the update server notes the file cannot be found and returns at step 424. If the file is found in the hash table, at step 430 the update processor finds the partition in which the file is located. At step 432, the update processor deletes the metadata and/or tags associated with the file for deletion and updates the partition's bloom filters, kd-tree, and kv-stores. At step 434, the update processor writes a commit message indicating that the tasks in the update message that were noted in the message log at step 404 have been completed prior to returning at step 424.

In an embodiment, as discussed in further detail below, the combination of the message log of step 404 and the commit log of steps 422 and 434 is used to implement a system backup. For example, one or more update messages are passed to an index server, for example server 200 in FIG. 2, with only a portion of those update messages being successfully executed. The combination of message logs and commit logs are examined to determine which update messages have been successfully executed, which update messages have begun execution but were not completed, and what update messages have yet to begin execution. Such a backup system may be implemented in a manner that allows the server to automatically resume after a failure by matching commit log entries to message log entries and update messages.

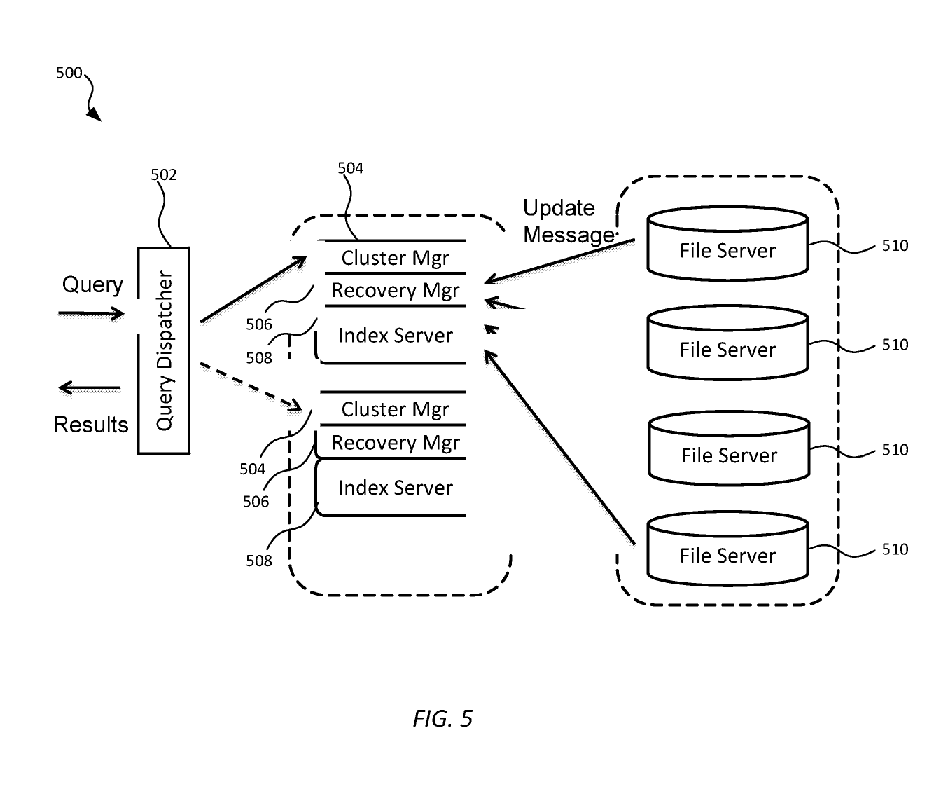

FIG. 5 is a schematic diagram of an embodiment of an index server cluster system 500. In an embodiment, server 200, shown above in FIG. 2, is scalable and capable of integration into a cluster-based system, such as system 500. System 500 comprises a query dispatcher 502, one or more clusters comprising a cluster manager 504, a recovery manager 506, an index server 508, such as server 200, shown in FIG. 2, and one or more file servers 510 for data storage. The query dispatcher is configured to interface between a user and the remainder of system 500 by routing queries received from the user to the cluster manager 504, as well as returning query results to the user from the clusters of system 500. It is understood that the query dispatcher 502, clusters, and file servers 510 may exist in a cloud computing environment and do not necessarily have to be co-located on a single device or in a single location, for example, the same data center.

Cluster manager 504 directs the functions of each cluster of system 504 according to queries received from the query dispatcher 502. For example, after receiving a query from query dispatcher 502, the cluster manager 504 passes the query to the index server 508 for processing according to processes 300 and 400, disclosed above (e.g., searching a file server 510 for the existence of a file having certain metadata and/or tag attributes and/or updating the metadata and/or tag attributes of a file). A plurality of clusters, each comprising an index server 508, is implemented in parallel with each query being transmitted to the cluster manager 504 of each cluster. In one embodiment, a query may be executed by a particularly designated index server 508. In other embodiments, a query may be executed by an available index server 508 that is determined by the query dispatcher 502.

Recovery manager 506 is configured to aid system 500 in recovering from a system failure by utilizing message and commit logs, as described in process 400, shown in FIG. 4. When an index server 508 fails, the query dispatcher 502 removes that index server 508 from the available set of index servers 508 for determining query assignments. The failed index server 508 is brought back to an operational status and recovers via recovery manager 506. Prior to an index server 508 executing an update message, the update message is logged by the recovery manager 506. After successful execution of the update message, a commit log entry is entered by the recovery manager 506 to signify that the first logged message has been completed. When an index server 508 fails, it recovers according to the logs maintained by recovery manager 506. For example, if a failed index server 508 failed after commit Log #100, the index server 508 must obtain updated message logs beginning with message Log #101 and continuing to the newest operation received by system 500, and then update all index data structures accordingly. By implementing such a log based system recovery method, the system can be considered to have a backup to protect against failure.

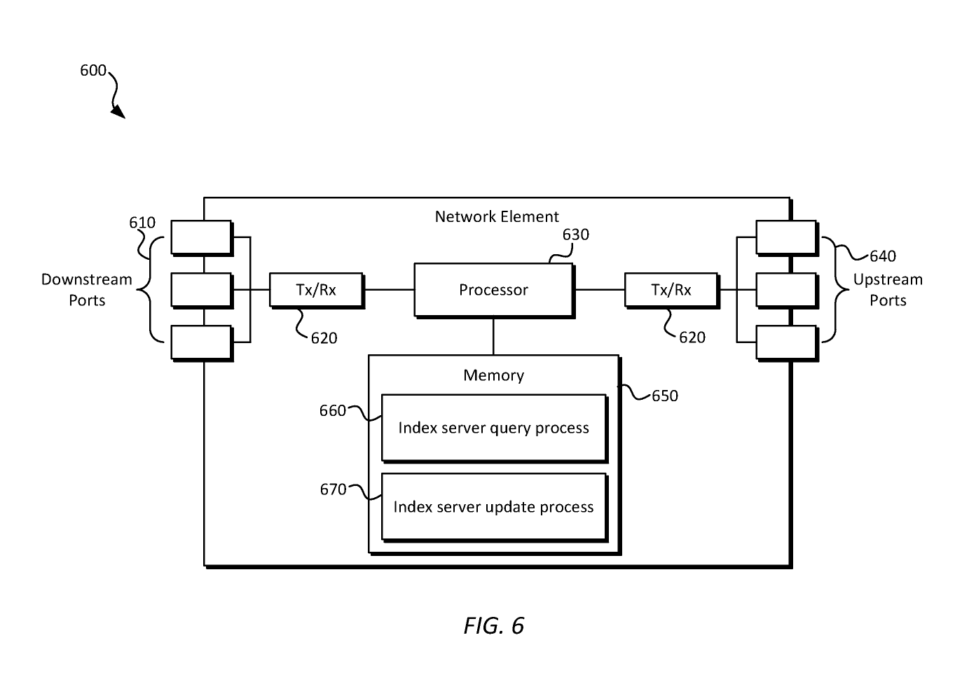

At least some of the features/methods described in this disclosure may be implemented in a network element (NE) 600. For instance, the features/methods of this disclosure may be implemented using hardware, firmware, and/or software installed to run on hardware. The network element may be any device that transports data through a network, e.g., a switch, router, bridge, server, client, etc. FIG. 6 is a schematic diagram of an embodiment of a network element 600 that may be used to process index server queries and/or updates as a server 200, shown in FIG. 2. The network element 600 may be any device (e.g., an access point, an access point station, a router, a switch, a gateway, a bridge, a server, a client, a user-equipment, a mobile communications device, etc.) which transports data through a network, system, and/or domain. Moreover, the terms network “element,” network “node,” network “component,” network “module,” and/or similar terms may be interchangeably used to generally describe a network device and do not have a particular or special meaning unless otherwise specifically stated and/or claimed within the disclosure. In one embodiment, the network element 600 may be an apparatus configured to support a plurality of storage partitions, each capable of an indexing, search, and update structure as described in process 300 and/or process 400.

The network element 600 may comprise one or more downstream ports 610 coupled to a transceiver (Tx/Rx) 620, which may be transmitters, receivers, or combinations thereof. The Tx/Rx 620 may transmit and/or receive frames from other network nodes via the downstream ports 610. Similarly, the network element 600 may comprise another Tx/Rx 620 coupled to a plurality of upstream ports 640, wherein the Tx/Rx 620 may transmit and/or receive frames from other nodes via the upstream ports 640. The downstream ports 610 and/or the upstream ports 640 may include electrical and/or optical transmitting and/or receiving components. In another embodiment, the network element 600 may comprise one or more antennas coupled to the Tx/Rx 620. The Tx/Rx 620 may transmit and/or receive data (e.g., packets) from other network elements wirelessly via one or more antennas.

A processor 630 may be coupled to the Tx/Rx 620 and may be configured to process the frames and/or determine to which nodes to send (e.g., transmit) the packets. In an embodiment, the processor 630 may comprise one or more multi-core processors and/or memory modules 650, which may function as data stores, buffers, etc. The processor 630 may be implemented as a general processor or may be part of one or more application specific integrated circuits (ASICs), field-programmable gate arrays (FPGAs), and/or digital signal processors (DSPs). Although illustrated as a single processor, the processor 630 is not so limited and may comprise multiple processors. The processor 630 may be configured to communicate and/or process multi-destination frames.

FIG. 6 also illustrates that a memory module 650 may be coupled to the processor 630 and may be a non-transitory medium configured to store various types of data. Memory module 650 may comprise memory devices including secondary storage, read-only memory (ROM), and random-access memory (RAM). The secondary storage is typically comprised of one or more disk drives, optical drives, solid-state drives (SSDs), and/or tape drives and is used for non-volatile storage of data and as an over-flow storage device if the RAM is not large enough to hold all working data. The secondary storage may be used to store programs that are loaded into the RAM when such programs are selected for execution. The ROM is used to store instructions and perhaps data that are read during program execution. The ROM is a non-volatile memory device that typically has a small memory capacity relative to the larger memory capacity of the secondary storage. The RAM is used to store volatile data and perhaps to store instructions. Access to both the ROM and RAM is typically faster than to the secondary storage.

The memory module 650 may be used to house the instructions for carrying out the various embodiments described herein. In one embodiment, memory module 650 may comprise an index server query process 660 which may be implemented on processor 630 and configured to search an index of a partition of a data storage device according to process 300, discussed above and shown in FIG. 3. In another embodiment, memory module 650 may comprise an index server update process 670 which may be implemented on processor 630 and configured to update metadata and/or tags in an index of a partition of a data storage according to process 400, discussed above and shown in FIG. 4.

It is understood that by programming and/or loading executable instructions onto the network element 600, at least one of the processor 630 and/or the memory 650 are changed, transforming the network element 600 in part into a particular machine or apparatus, for example, a multi-core forwarding architecture having the novel functionality taught by the present disclosure. It is fundamental to the electrical engineering and software engineering arts that functionality that can be implemented by loading executable software into a computer can be converted to a hardware implementation by well-known design rules known in the art. Decisions between implementing a concept in software versus hardware typically hinge on considerations of stability of the design and number of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable and will be produced in large volume may be preferred to be implemented in hardware (e.g., in an ASIC) because for large production runs the hardware implementation may be less expensive than software implementations. Often a design may be developed and tested in a software form and then later transformed, by well-known design rules known in the art, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

Any processing of the present disclosure may be implemented by causing a processor (e.g., a general purpose multi-core processor) to execute a computer program. In this case, a computer program product can be provided to a computer or a network device using any type of non-transitory computer readable media. The computer program product may be stored in a non-transitory computer readable medium in the computer or the network device. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), compact disc read-only memory (CD-ROM), compact disc recordable (CD-R), compact disc rewritable (CD-R/W), digital versatile disc (DVD), Blu-ray (registered trademark) disc (BD), and semiconductor memories (such as mask ROM, programmable ROM (PROM), erasable PROM, flash ROM, and RAM). The computer program product may also be provided to a computer or a network device using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. An apparatus for processing queries in a heterogeneous index, comprising:
a receiver configured to receive a query from a user, wherein the query comprises at least one desired attribute of a desired file;
a processor coupled to the receiver and configured to search the heterogeneous index by:
receiving the query from the receiver;
testing a bloom filter of a storage partition that comprises a plurality of data structures comprising a k-dimensional tree (kd-tree) and a key-value store (kv-store) in the heterogeneous index for existence of the desired attribute after receipt of the query;
ignoring the storage partition and proceeding to a next storage partition in the heterogeneous index when the bloom filter indicates that the desired attribute is not present in the storage partition; and
searching the storage partition to determine which one or more files of the storage partition have the desired attribute when the bloom filter indicates that the desired attribute is present in the storage partition.

2. The apparatus of claim 1, wherein searching the storage partition to determine which of the one or more files have the desired attribute comprises searching the kd-tree prior to searching the kv-store.

3. The apparatus of claim 1, wherein searching the storage partition to determine which of the one or more files have the desired attribute comprises searching the kv-store prior to searching the kd-tree.

4. The apparatus of claim 1, wherein searching the storage partition to determine which of the one or more files have the desired attribute comprises searching the kd-tree and the kv-store substantially simultaneously.

5. The apparatus of claim 1, wherein searching the storage partition to determine which of the one or more files have the desired attribute comprises:
testing the kd-tree in the storage partition to determine whether the desired attribute is desired metadata when the bloom filter indicates that the desired attribute is present in the storage partition;
searching a kd-tree index in the storage partition to determine which of the one or more files of the storage partition have the desired metadata when the desired metadata is present in the kd-tree;
testing the key-value in the storage partition to determine whether the desired attribute is a desired tag when the desired attribute is not located in the kd-tree or after searching the kd-tree index;
searching a kv-store index in the storage partition to determine which of the one or more files of the storage partition have the desired tag when the desired tag is present in the kv-store;
testing the query to determine whether all of the desired attributes were found in the kd-tree or the kv-store when the desired attribute is not present in the kv-store or after searching the kv-store index;
scanning the storage partition for any of the one or more files containing the desired attributes when one or more of the desired attributes remain that were not found in the kd-tree or the kv-store; and
joining the search and scan functions results when any of the desired attributes of the query were found in two or more of the kd-tree or the kv-store or after scanning the storage partition.

6. The apparatus of claim 5, wherein one or more attributes are associated with each of the one or more files in the storage partition, and wherein the attributes comprise metadata or tags.

7. The apparatus of claim 6, wherein the tags are indexed in the storage partition and organized into categories, and wherein the storage partition comprises one kv-store for each tag category.

8. The apparatus of claim 6, wherein the metadata is dynamically added and indexed in the storage partition and organized into categories, and wherein the storage partition further comprises one kv-store for each dynamically added metadata category.

9. The apparatus of claim 6, wherein the storage partition comprises one kd-tree for indexing fixed categories of the metadata.

10. The apparatus of claim 5, wherein the query comprises at least two desired attributes comprising both metadata and tags.

11. The apparatus of claim 5, wherein the storage partition comprises one bloom filter for each category of attributes indexed in the partition.

12. A method for updating a heterogeneous search index for a storage partition comprising a plurality of data structures, comprising:
receiving an update message from a user, wherein the update message indicates an operation to be performed on the heterogeneous search index that comprises attributes comprising metadata and tags;
recording a log entry indicating receipt of the update message from the user;
determining the operation that is to be performed according to the update message;
updating the heterogeneous search index according to the update message; and
recording a log entry indicating that the update message received from the user was executed successfully.

13. The method of claim 12, wherein the storage partition comprises one or more files, a k-dimensional tree, one or more key-value stores, and a number of bloom filters equal to a number of categories of attributes that are indexed in the storage partition.

14. The method of claim 12, wherein updating the heterogeneous search index according to the update message comprises:
updating the attributes in the heterogeneous search index when a new file is inserted into the storage partition;
updating the attributes in the heterogeneous search index for a pre-existing file in the storage partition; or
deleting the attributes from the heterogeneous search index for a file removed from the storage partition.

15. The method of claim 14, wherein updating the attributes in the heterogeneous search index when the new file is inserted into the storage partition comprises:
determining whether the new file is in a hash table of the storage partition;
treating the new file as the pre-existing file when it is determined that the new file is in the hash table of the storage partition;
determining whether the storage partition has space available for the new file when it is determined that the new file is not in the hash table;
using the storage partition as a current storage partition when it is determined that space is available in the storage partition for the new file;
creating a new storage partition when it is determined that space is not available in the storage partition for the new file;
setting the new storage partition as the current storage partition;
updating the hash table to indicate that the new file is located in the new storage partition; and
inserting index attributes into the current storage partition, updating bloom filters of the current storage partition, updating a k-dimensional tree of the current storage partition, and updating key-value stores of the current storage partition.

16. The method of claim 14, wherein updating the attributes in the heterogeneous search index for the pre-existing file in the storage partition comprises:
determining whether the pre-existing file is in a hash table of the storage partition;
treating the pre-existing file as a new file when it is determined that the pre-existing file is not in the hash table of the storage partition;
finding the pre-existing file in the storage partition when it is determined that the pre-existing file is in the hash table of the storage partition; and
inserting index attributes into the storage partition, updating bloom filters of the storage partition, updating a k-dimensional tree of the storage partition, and updating key-value stores of the storage partition.

17. The method of claim 14, wherein deleting attributes from the heterogeneous search index for the file removed from the storage partition comprises:
determining whether the file is in a hash table of the storage partition;
finding the storage partition in which the file is located when it is determined that the file is in the hash table of the storage partition;
deleting index attributes from the storage partition, updating bloom filters of the storage partition, updating a k-dimensional tree of the storage partition, and updating key-value stores of the storage partition; and
determining that the file cannot be found when it is determined that the file is not in the hash table of the storage partition.

18. The method of claim 14, wherein the attributes comprise metadata stored in a k-dimensional tree or tags stored in at least one key-value store.

19. The method of claim 12, wherein the log entries comprises a log-based backup of the heterogeneous search index.

20. A method of recovering from a system failure in a heterogeneous search index comprising:
entering a plurality of actions to be performed into a log at a time of receipt prior to execution of the actions, wherein the actions to be performed comprise at least two of:
updating a bloom filter of the heterogeneous search index that indicates an existence of a tag or metadata in the heterogeneous search index;
updating a k-dimensional tree of the heterogeneous search index; and
updating a key-value store of the heterogeneous search index; and
entering the actions performed into the log at a time of completion to indicate successful execution of a first of the actions and a progression to a second of the actions.

21. The method of claim 20, wherein recovering from the system failure comprises determining, according to the log, an action of the plurality of actions for which a log entry prior to execution exists without a corresponding log entry indicating successful execution.

22. The method of claim 21, wherein recovering from the system failure further comprises obtaining and executing all actions of the plurality of actions from a last log entry that indicates successful execution of a last performed action of the plurality of actions to a most recently received action of the plurality of actions.

23. The method of claim 20, wherein the method is implemented by a recovery manager in a distributed computing environment.
